(19) United States
(12) Patent Application Publication
(10) Pub. No.: US 2010/0092713 A1
(43) Pub. Date: Apr. 15, 2010

(54) SCREEN PROTECTOR AND METHOD OF USING SAME

(75) Inventors: Robert B. Bullard, Monroe, NC (US); Robert H. Bullard, Monroe, NC (US)

Correspondence Address: ASHLEY LAW FIRM P.C., 3440 TORINGDON WAY, SUITE 205, CHARLOTTE, NC, 28277, US

(73) Assignee: ITCO International, Inc., Monroe, NC (US)

(21) Appl. No.: 12/251,003

(22) Filed: Oct. 14, 2008

(51) Int. Cl. B32B 3/26; C08L 23/04; C08L 23/06; B32B 27/06; B41M 1/12; B32B 27/32; B32B 27/36

(52) U.S. Cl. 428/40.1; 101/129; 524/878; 524/855; 428/317.3

(57) ABSTRACT

A screen protector for use on a mesh screen in a screen printing process can include a layer of protective material such as a polyester film, and a pressure sensitive adhesive on a surface of the polymeric film for adhering the layer to the mesh screen. The screen protector supports the mesh screen and helps prevent premature fraying of the screen. The adhesive can be an acrylic based pressure sensitive adhesive that substantially retains its adhesion properties when in contact with ink. The protector remains substantially attached to the mesh screen when in contact with ink, and therefore no filler material is needed.

### TECHNICAL FIELD AND BACKGROUND OF THE INVENTION

The present invention relates to an article for protecting the screens used in screen printing processes. One embodiment of the invention provides a screen protector with a a pressure sensitive adhesive that does not require the use of a filler or drying oven.

Screen printing has been used for many years to imprint images on various objects. Screen printing can be used to print on a variety of materials such as textiles, ceramics, wood, paper, glass, metal, and plastic. As such, screen printing can be used on a wide variety of products, such as clothing, plastic bottles, and product packaging. Screen printing is also used to print on compact discs and DVD's.

Screen printing typically utilizes a mesh screen comprised of a porous fabric, such as silk, attached to a square or rectangular frame, and an ink blocking stencil positioned on the screen. Ink is poured onto the screen and a squeegee, roller or other like device is moved across the mesh screen to move the ink through the open areas of the screen. The repeated back and forth action of the squeegee causes significant wear and tear on the mesh screen, which is typically made of silk or other porous fabric. Such screens are generally expensive, and therefore screen protectors have been developed to strengthen and protect the screen, and help prevent premature fraying of the screen. Such screen protectors are typically made of plastic, and have an adhesive on one side for attaching the protector to the back side of the screen. However, in order to use such screen protectors a filler material, such as the product sold under the name COATAZOL by Sun Chemical, must be applied to the screen before adhering the protector. The filler material is applied in any area where ink is not supposed to penetrate the screen, in order to prevent the ink from seeping into the adhesive of the screen protector, which typically causes the adhesive and protector to bubble up and peel off. Generally, after applying such fillers to the screen, it must be dried in an oven for approximately twenty minutes before the protector is attached. As such, applying and drying the filler material adds substantial time and costs to the screen printing process.

### SUMMARY OF OBJECTS AND EMBODIMENTS OF THE INVENTION

Therefore, one object of the present invention is to provide a screen protector for use on a mesh screen in a screen printing process that does not require the use of a filler. Another object of the invention is to provide a screen protector particularly suited for use in screen printing compact discs and DVD's.

These and other objects of the invention can be achieved in the various embodiments of the invention described below. In one embodiment of the invention, an article for protecting a mesh screen in a screen printing process includes a layer of protective material, and a pressure sensitive adhesive on a surface of the layer of protective material for adhering the layer to the mesh screen. The adhesive substantially retains its adhesion properties when in contact with ink.

According to another embodiment of the invention, the layer of protective material can be a polyester film, polypropylene film or polyethylene film.

According to another embodiment of the invention, the pressure sensitive adhesive is comprised of a pressure sensitive acrylic based adhesive.

According to another embodiment of the invention, the layer of protective material remains substantially attached to the mesh screen when in contact with ink.

According to another embodiment of the invention, the adhesive prevents penetration of the ink through the mesh screen when the article is adhered to the screen.

According to another embodiment of the invention, a removable release liner covers the adhesive, such that the liner can be removed immediately prior to use of the article to expose the adhesive.

According to another embodiment of the invention, the layer of protective material has an opening therein for providing an area through which ink can pass through when the article is used on a mesh screen in a screen printing process.

According to another embodiment of the invention, the opening defined by the layer of protective material can be a substantially circular opening positioned proximate a center of the layer of protective material.

According to another embodiment of the invention, the substantially circular opening can have a diameter of about twelve centimeters.

According to another embodiment of the invention, a screen protector for use on a mesh screen in a screen printing process comprises a polymeric film, and a pressure sensitive adhesive on a surface of the polymeric film for adhering the film to the mesh screen. The screen protector supports the mesh screen and the adhesive substantially retains its adhesion properties when in contact with ink.

According to another embodiment of the invention, the polymeric film is comprised of polyester, polyethylene and/or polypropylene.

According to another embodiment of the invention, the pressure sensitive adhesive can be a pressure sensitive acrylic adhesive.

According to another embodiment of the invention, the polymeric film remains substantially attached to the mesh screen when in contact with ink.

According to another embodiment of the invention, the opening in the polymeric film comprises a substantially circular opening positioned proximate the center of the polymeric film. The circular opening can have a diameter of about twelve centimeters, so that the screen protector can be used in screen printing of compact discs and digital versatile discs (DVD's).

According to another embodiment of the invention, a method of screen printing can include the steps of providing a mesh screen having a first side and a second side, and a screen protector comprising a polymeric film, a pressure sensitive adhesive positioned on a surface of the polymeric film for adhering the layer to the mesh screen, and a removable release liner covering the adhesive. The release liner is removed to expose the adhesive, and the protector is adhered to at least a portion of the first side of the mesh screen. Ink is poured onto the second side of the mesh screen.

According to another embodiment of the invention, no filler material is applied to the mesh screen.

According to another embodiment of the invention, the polymeric film remains substantially attached to the mesh screen when in contact with the ink, even when no filler is used.

### BRIEF DESCRIPTION OF THE DRAWINGS

Objects of the invention have been set forth above. Further objects and advantages of the present invention may become apparent as the description of the invention proceeds when taken in conjunction with the following drawings, in which:

FIG. 1 is a perspective view of a screen protector according to a preferred embodiment of the invention;

FIG. 2 is another perspective view of the screen protector of FIG. 1;

FIG. 3 is an environmental perspective view of the screen protector of FIG. 1; showing the screen protector being applied to a mesh screen;

FIG. 4 is an environmental perspective view illustrating a preferred method of using the screen protector of FIG. 1; and

FIG. 5 is another environmental perspective view illustrating a preferred method of using the screen protector of FIG. 1.

### DESCRIPTION OF THE PREFERRED EMBODIMENTS AND BEST MODE

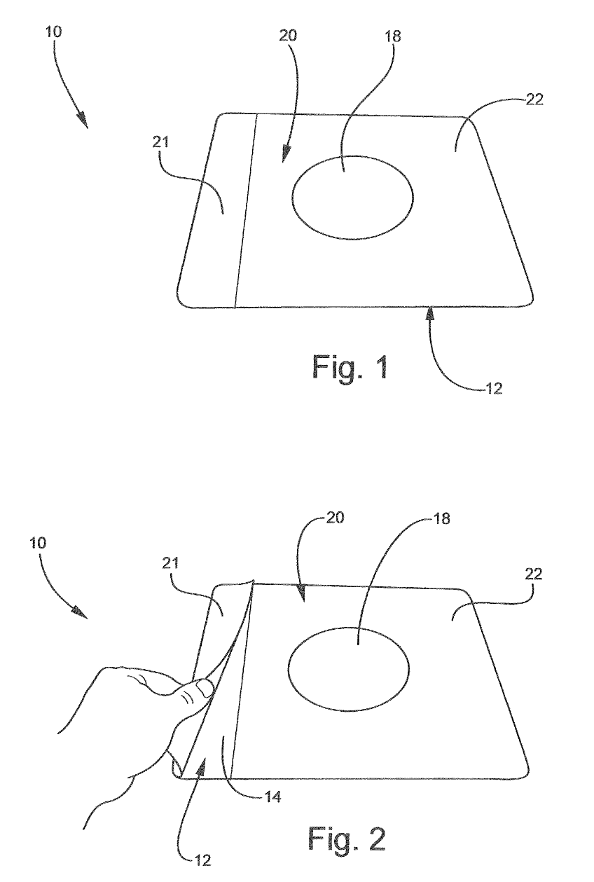

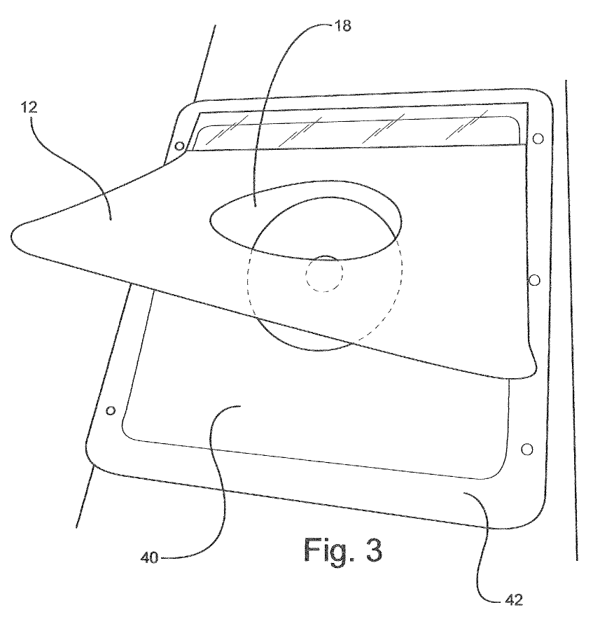

Referring now to the drawings, in which like numerals represent like components throughout, a screen protector according to a preferred embodiment of the invention for use in a screen printing process is illustrated in FIG. 1, and shown generally at reference numeral 10. The screen protector 10 comprises a layer of protective material, which can be a polymeric film 12, such as polyester film, polypropylene film and/or polyethylene film. The protective material can be a variety of materials so long as it provides sufficient support and protection to a mesh screen being used in a screen printing process.

A pressure sensitive adhesive 14 is applied to the top surface of the protective polymeric film 12. The pressure sensitive adhesive 14 is preferably an acyrlic based pressure sensitive adhesive, such as the adhesive currently sold by Flexcon under the name optiFLEX® RESEAL. Other pressure sensitive adhesives that can be utilized in the protector 10 include, but are not limited to, rubber based pressure sensitive adhesives and hot melt pressure sensitive adhesives.

A removable release liner 20 is positioned over the top of the protective film 12, and covers the adhesive 14. The liner 20 can be separated into two sections 21, 22 to assist the user in peeling away the liner, as shown in FIG. 2. The liner 20 can be made of paper, and covers the adhesive 14 until the user wishes to use the screen protector 10.

The screen protector 10 has an opening 18 formed therein for allowing ink to pass therethrough during screen printing. As shown in FIGS. 1 and 2, the opening 18 can have a circular shape and can be positioned in the center of the protector 10.

In a preferred method of using the screen protector 10, the screen protector 10 can be utilized to protect and support a mesh screen 40 being used in a screen printing process. The mesh screen 40 can be comprised of silk or other porous fabric, such as is typically used in screen printing processes, and attached to a square frame 42. The user peels away the paper liner 20 from the rest of the protector, as shown in FIG. 2, thereby exposing the adhesive 14 on the top surface of the polymeric film 12. The top surface of the protector 10 is applied to the back side of the mesh screen 40 and the screen frame 42. The protector 10 is adhered to the screen 40 and the screen frame 42 via the adhesive 14.

As noted above, a circular opening 18 can be formed in the center of the protector 10. The circular opening 18 can have a diameter of about twelve centimeters, which is the standard diameter of many compact discs and digital versatile discs (DVD's). As such, the protector 10 is particularly suited for use in the screen printing of compact discs and DVD's. Although, it should be noted that the opening 18 in the protector 10 can be of any variety of shapes and sizes to accommodate the screen printing of all kinds of objects to be screen printed. Furthermore, the protector can have a plurality of openings 18 formed therein.

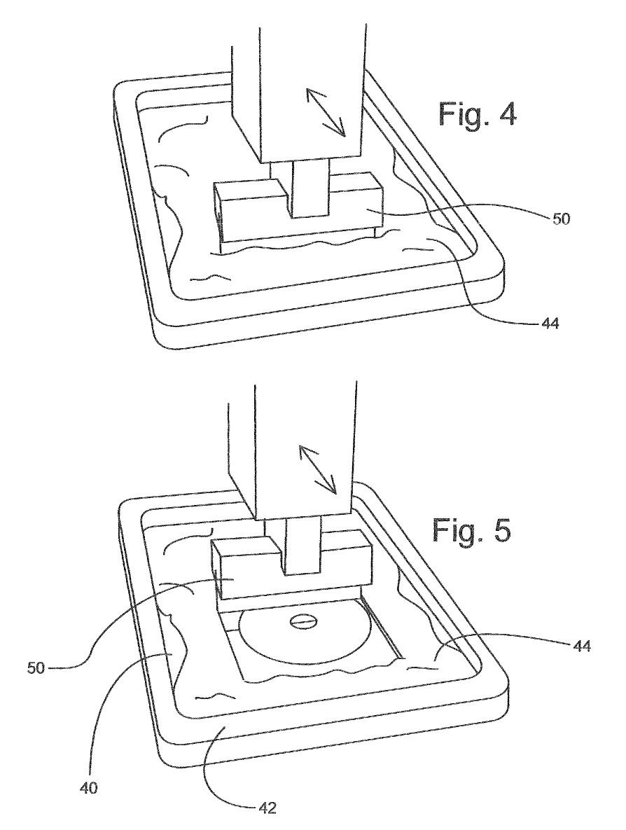

As shown in FIGS. 4 and 5, ink 44 is poured on the top of the mesh screen 40 and moved back and forth by a squeegee 50. The protector 10 adhered to the back side of the screen 40 and screen frame 42 provides added strength and support to the screen 40 as it undergoes the repeated back and forth motion of the squeegee 50. As such, the protector 10 prevents premature wear and tear on the screen 40 and extends the life of the screen 40. Furthermore, the adhesion properties of the pressure sensitive adhesive are not diminished by contact with the ink 44. As such, the protector 10 remains in place, preventing ink from penetrating through to undesired areas, while the opening 18 of the protector 10 allows the ink to pass through the desired area of the screen 40. Because the pressure sensitive adhesive 14 is unaffected by contact with ink, there is no need for a filler material to block ink from the protector 10. As such, the twenty minute oven drying process that is typically necessary with the use of a filler is not needed when using the screen protector 10 of the present embodiment of the invention in a screen printing process. This results in a significant reduction in the overall time and expense of the screen printing process.

A screen protector and a method of using same are described above. Various details of the invention may be changed without departing from its scope. The foregoing description of the various embodiments of the invention and the best mode for practicing the invention are provided for the purpose of illustration only and not for the purpose of limitation—the invention being defined by the following claims and equivalents thereof

What is claimed is:

1. An article for protecting a mesh screen in a screen printing process comprising:
(a) a layer of protective material; and
(b) a pressure sensitive adhesive positioned on a surface of the layer of protective material for adhering the layer to the mesh screen, and wherein the adhesive substantially retains adhesion properties when in contact with ink.

2. An article according to claim 1, wherein the layer of protective material comprises one or more selected from the group consisting of polyester film, polypropylene film and polyethylene film.

3. An article according to claim 1, wherein the pressure sensitive adhesive comprises one or more selected from the group consisting of an acrylic based pressure sensitive adhesive, a rubber based pressure sensitive adhesive and a hot melt pressure sensitive adhesive.

4. An article according to claim 1, wherein the layer of protective material remains substantially attached to the mesh screen when in contact with ink.

5. An article according to claim 1, wherein the adhesive prevents penetration of the ink through the mesh screen when the article is adhered to the screen.

6. An article according to claim 1, further comprising a removable release liner covering the adhesive, wherein the liner can be removed immediately prior to use of the article to expose the adhesive.

7. An article according to claim 1, wherein the layer of protective material defines an opening therein for providing an area through which ink can pass through when the article is used on a mesh screen in a screen printing process.

8. An article according to claim 1, wherein the opening defined by the layer of protective material comprises a substantially circular opening positioned proximate a center of the layer of protective material.

9. An article according to claim 8, wherein the substantially circular opening has a diameter of about twelve centimeters.

10. A screen protector for use on a mesh screen in a screen printing process comprising:
(a) a polymeric film; and
(b) a pressure sensitive adhesive positioned on a surface of the polymeric film for adhering the polymeric film to the mesh screen, wherein the screen protector supports the mesh screen and the adhesive substantially retains adhesion properties when in contact with ink.

11. A screen protector according to claim 10, wherein the polymeric film comprises one or more selected from the group consisting of polyester, polypropylene and polyethylene.

12. A screen protector according to claim 10, wherein the pressure sensitive adhesive comprises a pressure sensitive acrylic adhesive.

13. A screen protector according to claim 10, wherein the polymeric film remains substantially attached to the mesh screen when in contact with ink.

14. A screen protector according to claim 10, wherein the adhesive prevents penetration of the ink through the mesh screen when the screen protector is adhered to the screen.

15. A screen protector according to claim 10, further comprising a removable release liner covering the adhesive, wherein the liner can be removed immediately prior to use of the screen protector to expose the adhesive.

16. A screen protector according to claim 10, wherein the polymeric film defines an opening therein for providing an area through which ink can pass through when the screen protector is used on a mesh screen in a screen printing process.

17. A screen protector according to claim 1, wherein the opening defined by the polymeric film comprises a substantially circular opening positioned proximate a center of the polymeric film, and further wherein the circular opening has a diameter of about twelve centimeters, whereby the screen protector is adapted for use in screen printing of compact discs and digital versatile discs.

18. A method of screen printing comprising the steps of:
(a) providing a mesh screen having a first side and a second side;
(b) providing a screen protector comprising:
(i) a polymeric film,
(ii) a pressure sensitive adhesive positioned on a surface of the polymeric film for adhering the film to the mesh screen, and
(iii) a removable release liner covering the adhesive;
(c) removing the release liner to expose the adhesive;
(d) adhering the protector to at least a portion of the first side of the mesh screen; and
(e) pouring ink on the second side of the mesh screen.

19. A method according to claim 18, wherein the screen printing method does not include application of a filler material to the mesh screen.

20. A method according to claim 19, wherein the polymeric film remains substantially attached to the mesh screen when in contact with the ink.
